(19) United States
(12) Patent Application Publication
(10) Pub. No.: US 2010/0066635 A1
(43) Pub. Date: Mar. 18, 2010

(54) MICROWAVE SPARSE ARRAY ANTENNA ARRANGEMENT

(76) Inventors: Ulf Lindgren, Vastra Frolunda (SE); Fredrik Athley, Kullavik (SE)

Correspondence Address: ERICSSON INC., 6300 LEGACY DRIVE, M/S EVR 1-C-11, PLANO, TX, 75024, US

(21) Appl. No.: 12/517,130

(22) PCT Filed: Nov. 30, 2006
(86) PCT No.: PCT/SE2006/050532

§ 371 Date: Jun. 1, 2009

(51) Int. Cl. H01Q 21/06

(52) U.S. Cl. 343/893

(57) ABSTRACT

A microwave array antenna arrangement comprising at least two groups of antenna elements and at least two antenna elements in each group. All groups comprise an equal amount of antenna elements, where the arrangement further comprises one radio chain for each group of antenna elements. The arrangement also comprises one switch for each radio chain, the switches being arranged for cyclically connecting each radio chain to the antenna elements in each respective group of antenna elements.

### TECHNICAL FIELD

The present invention relates to a microwave array antenna arrangement comprising at least two groups of antenna elements and at least two antenna elements in each group, all groups comprising an equal amount of antenna elements, where the arrangement further comprises one radio chain for each group of antenna elements.

### BACKGROUND

Today, array antennas are used for a wide variety of applications. Examples of such applications are base station antennas and antennas arranged for estimating a so-called direction of arrival (DOA).

An array antenna generally consists of a number of antenna elements. Typically, the antenna elements are arranged equidistantly along a line. A common mathematical description of a complex beam pattern for such an array antenna having K antenna elements is expressed as

$$H ( λ , d , θ , φ ) = g ( λ , θ , φ ) {\sum }_{k = 1}^{K} {w}_{k} {e}^{\frac{2 j π dk}{λ} cos ( θ )} , \qquad ( 1 )$$

where g(λ,θ,φ) is a function that describes a particular antenna element, the element factor, and the sum

$${\sum }_{k = 1}^{K} {w}_{k} {e}^{\frac{2 j π dk}{λ} cos ( θ )}$$

is the array factor. Furthermore, d is the distance between the antenna elements, k is the number of a certain antenna element, λ is the used wavelength and wₖ is an antenna element gain weight factor. The angles θ and φ are angular directions in azimuth and elevation, respectively. The antenna gain response can be altered by means of the gain weight factors wₖ, and a main lobe may be placed in a desired direction.

In order to avoid grating lobes, the distance d should be less than λ/2, but the coupling between adjacent antenna element increases with decreasing distance d. Reducing the number of antenna elements without decreasing the array antenna's effective aperture results in a so-called sparse array. A sparse array thus has the advantages compared to a full array of reduced coupling between the antenna elements comprised in the array antenna, more space for hardware, reduced weight, a reduced number of amplifiers and reduced power consumption. Naturally, the disadvantages are grating lobes and reduced antenna gain.

Since coupling between antenna elements is undesirable, there is a need for an array antenna that comprises antenna elements that are spaced apart in such a way that coupling is lowered and the number of amplifiers is reduced, constituting a sparse array, at the same time as grating lobes may easily be compensated for.

### SUMMARY

It is an object of the present invention to provide an array antenna comprising antenna elements where the antenna elements are spaced apart in such a way that coupling between the antenna elements is decreased and the number of amplifiers is reduced at the same time as compensation for grating lobes is allowed.

Said object is accomplished by means of an arrangement as mentioned initially, where the arrangement also comprises one switch for each radio chain, the switches being arranged for cyclically connecting each radio chain to the antenna elements in each respective group of antenna elements.

In a preferred embodiment, the antenna elements in each group of antenna elements are arranged essentially equidistantly.

In another preferred embodiment, the distance between the antenna elements in each group of antenna elements is chosen in such a way that grating lobes do not appear for the frequency band used.

In another preferred embodiment, each antenna element comprises a number of antenna sub-elements, each antenna element constituting a sub-array antenna.

In another preferred embodiment, the antenna elements are arranged essentially linearly or on a circular circumference.

In another preferred embodiment, only one antenna element per group of antenna elements is connected to a respective radio chain at a time, preferably during essentially the same amount of time.

There are two main varieties of the present invention. According to the first variety, the distance between two adjacent groups of antenna elements is essentially the same as the distance between the antenna elements in each group. According to the second variety, the distance between two adjacent groups of antenna elements is greater than the distance between the antenna elements in each group.

Other preferred embodiments are evident from the dependent claims.

The present invention presents a number of advantages, for example:
an array antenna is obtained where the amplifiers are re-used for at least two antenna elements; and
lower coupling is achieved between antenna elements.

### BRIEF DESCRIPTION OF DRAWINGS

The present invention will now be described more in detail, with reference to the appended drawings, where:

FIG. 1 shows an arrangement according to a first embodiment of the present invention;

FIG. 2 shows an arrangement according to a second embodiment of the present invention;

FIG. 3 shows an arrangement according to a third embodiment of the present invention; and

FIG. 4 shows an arrangement according to a fourth embodiment of the present invention.

### DETAILED DESCRIPTION

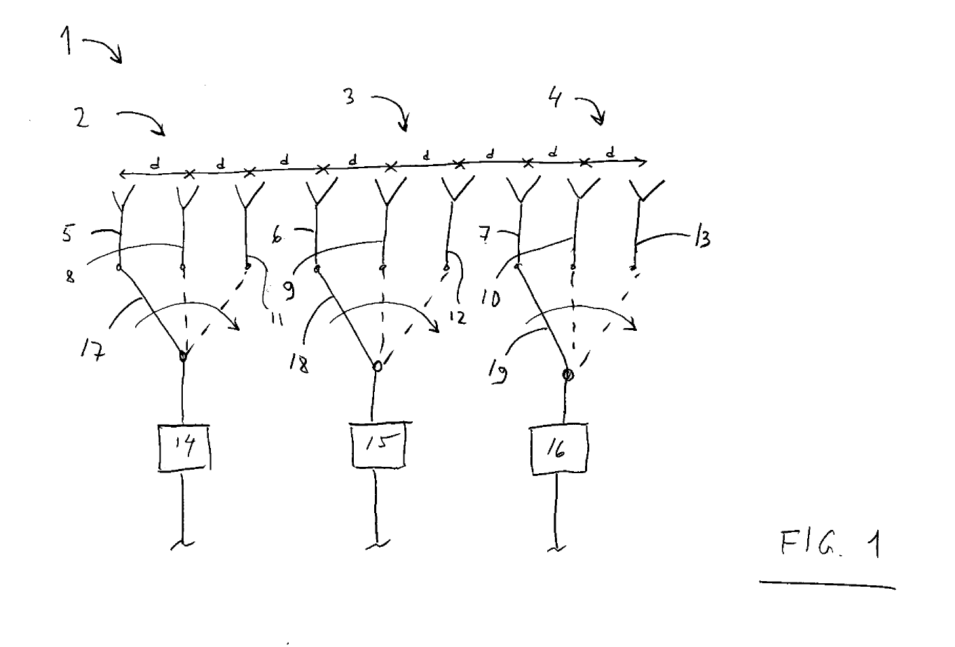

FIG. 1 shows a first embodiment of the present invention; an array antenna 1 comprising a first group of antenna elements 2, a second group of antenna elements 3 and a third group of antenna elements 4. Each group 2, 3, 4 comprises a first antenna element 5, 6, 7 a second antenna element 8, 9, 10 and a third antenna element 11, 12, 13 respectively. Totally, the array antenna comprises nine antenna elements 5, 6, 7; 8, 9, 10; 11, 12, 13, where the antenna elements 5, 6, 7; 8, 9, 10; 11, 12, 13 are arranged essentially equidistantly along a line. The distance d between adjacent antenna elements is λ/2, where λ is the wavelength that corresponds to the frequency used. In this case, no grating lobes would appear if all antenna elements 5, 6, 7; 8, 9, 10; 11, 12, 13 were engaged at the same time, for example coupled to a transmitter.

A first radio chain 14 is connected to the first group of antenna elements 2, a second radio chain 15 is connected to the second group of antenna elements 3, and a third radio chain 16 is connected to the third group of antenna elements 4. Each radio chain 14, 15, 16 comprises radio elements arranged for transmission, reception or both. The construction of radio chains is previously known, and will not be discussed further.

According to the present invention, each radio chain 14, 15, 16 is connected to the respective group of antenna elements 2, 3, 4 by means of a respective first switch 17, second switch 18 and third switch 19. Each switch 17, 18, 19 is arranged to switch the corresponding radio chain 14, 15, 16 between the three antenna elements 5, 8 11; 6, 9, 12; 7, 10, 13 in the corresponding group of antenna elements 2, 3, 4.

When regarding for example the first group of antenna elements 2, the first switch 17 switches between the first antenna element 5, second antenna element 8 and third antenna element 9 in the group 2. The antenna elements 5, 8, 9 are coupled to the first radio chain 14 during essentially the same quantity of time.

All the switches 17, 18, 19 switch in the same manner such that the first antenna element 5, 6, 7 in each group of antenna elements 2, 3, 4 is connected to its respective radio chain 14, 15, 16 at essentially the same time, the second antenna element 8, 9, 10 in each group of antenna elements 2, 3, 4 is connected to its respective radio chain 17, 18, 19 at essentially the same time and the third antenna element 11, 12, 13 in each group of antenna elements 2, 3, 4 is connected to its respective radio chain 17, 18, 19 at essentially the same time. Those antenna elements that are not coupled to a respective radio chain 17, 18, 19 at a certain time are preferably connected to a matched load.

This means that between two adjacent antenna elements 5, 6, 7; 8, 9, 10; 11, 12, 13 that are coupled to a radio chain 14, 15, 16 at a certain moment, the distance is 3d=1.5λ. Thus, at a certain moment in time, only one antenna element 5, 6, 7; 8, 9, 10; 11, 12, 13 per group of antenna elements 2, 3, 4 is connected to a respective radio chain 14, 15, 16, and thus the mutual coupling between the antenna elements is decreased compared to the case where all antenna elements 5, 8 11; 6, 9, 12; 7, 10, 13 in a group of antenna elements 2, 3, 4 are connected to a radio chain 14, 15, 16 at the same time. Since the distance between two neighbouring connected antenna elements 5, 6, 7; 8, 9, 10; 11, 12, 13 at that moment is 3d=1.5λ, which is more than the above-mentioned λ/2, grating lobes are formed.

The switching rate is relatively high, preferably so high that signals that are received and/or transmitted by the array antenna 1 vary slowly compared with the switching cycle time. This results in that the influence of the grating lobes is highly reduced. If the radio chains 14, 15, 16 for example work as receivers, and the received signals vary slowly compared to the switching cycle time, an array response equivalent to having one receiver per array element by using only one receiver per group of antenna elements is achieved.

The first embodiment thus constitutes a sparse array 1 that may be regarded as one polyphase function in an unambiguous array. The sum of the polyphase functions constitutes the antenna diagram of the full array antenna. This means that the antenna operates by periodically time varying weights wₖ in the expression in equation (1).

A symbol that is transmitted by the array antenna 1 according to the first embodiment shall preferably be applied to all antenna elements 5, 6, 7; 8, 9, 10; 11, 12, 13 during one full switch cycle. A receiver, adapted for receiving the symbol, gathers the symbol by means of summation.

The array antenna 1 according to the first embodiment which is arranged as a receiver can focus a unique beam for reception provided that the sent symbol exists during one full switch cycle.

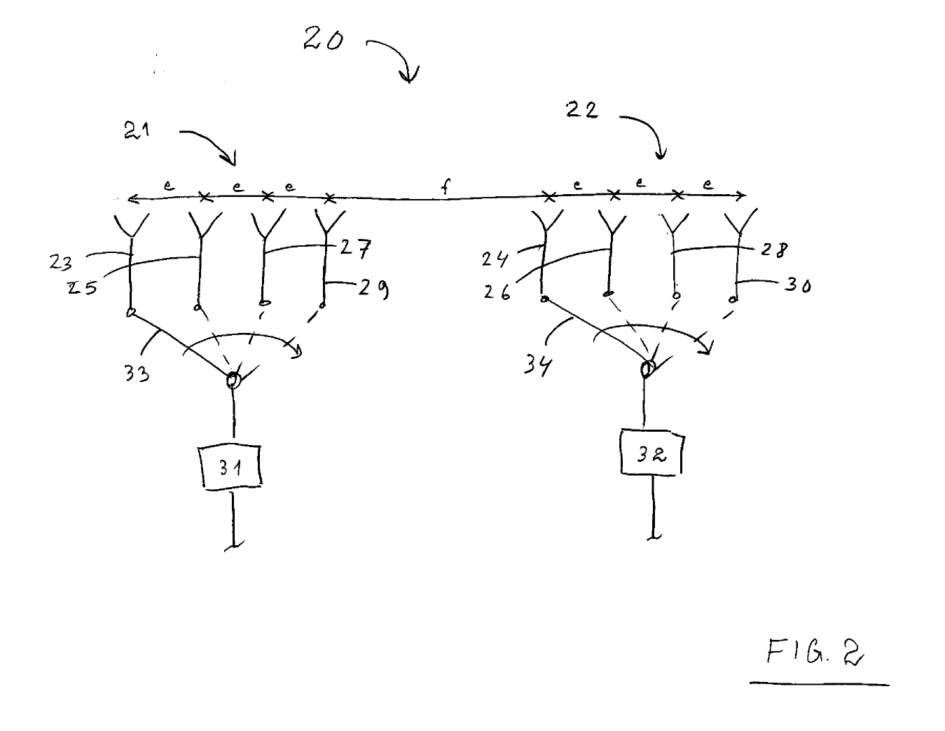

In FIG. 2, showing a second embodiment of the present invention, an array antenna 20 comprising a first group 21 of antenna elements and a second group of antenna elements 22 is shown. Each group 21, 22 comprises a first antenna element 23, 24, a second antenna element 25, 26, a third antenna element 27, 28 and a fourth antenna element 29, 30, respectively. Totally, the array antenna 20 comprises eight antenna elements 23, 24, 25, 26, 27, 28, 29, 30, where the antenna elements 23, 25, 27, 29; 24, 26, 28, 30 in each group of antenna elements 21, 22 are arranged essentially equidistantly along a line. The distance e between adjacent antenna elements 23, 25, 27, 29; 24, 26, 28, 30 in each group of antenna elements 21, 22 is λ/2, where λ is the wavelength that corresponds to the frequency used.

The groups of antenna elements 21, 22 are arranged in such a way that the antenna elements 23, 24, 25, 26, 27, 28, 29, 30 are placed essentially along a line, where the distance f between the groups of antenna elements 21, 22 is >>λ, preferably 5-10λ.

A first radio chain 31 is connected to the first group of antenna elements 21 and a second radio chain 32 is connected to the second group of antenna elements 22. Each radio chain 31, 32 comprises radio elements arranged for transmission, reception or both. The construction of radio chains is previously known, and will not be discussed further.

In the same way as for the first embodiment, each radio chain 31, 32 is connected to the respective group of antenna elements 21, 22 by means of respective switches, in this case a first switch 33 and a second switch 34. Each switch 33, 34 is arranged to switch the corresponding radio chain 31, 32 between the four antenna elements 23, 25, 27, 29; 24, 26, 28, 30 in the corresponding group of antenna elements 21, 22 cyclically in essentially the same way as described for the first embodiment.

The second embodiment constitutes a sparse array of a certain kind since it consists of two separated groups of antenna elements 21, 22. This type of sparse array is called an interferometric array. If the groups of antenna elements 21, 22 would consist of only one single antenna element each, a unique direction of arrival (DOA) estimation would be difficult due to grating lobes.

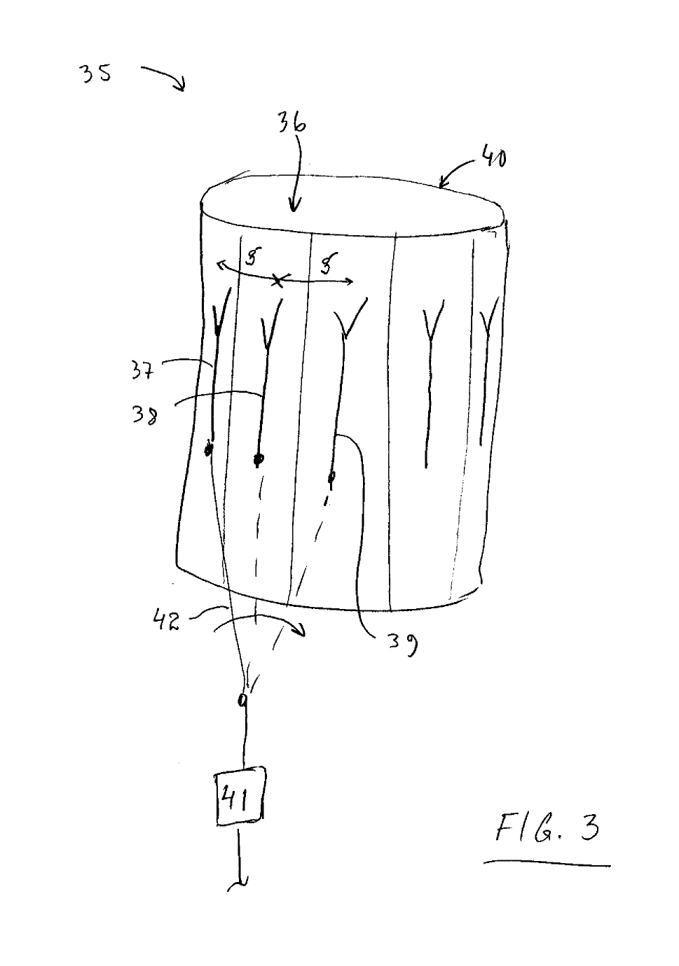

FIG. 3 shows a third embodiment of the present invention; an array antenna 35 comprising a number of groups 36 of antenna elements. Only one group is indicated in FIG. 3, although it is obvious that the array antenna 35 comprises more than this indicated group 36. The groups 36 each comprise a first antenna element 37, a second antenna element 38 and a third antenna element 39. The antenna elements 37, 38, 39 in the array antenna 35 are arranged essentially equidistantly along the circumference 40 of a circle. The distance g between adjacent antenna elements is λ/2, where λ is the wavelength that corresponds to the frequency used. This measure is not as important to this embodiment as for the previous ones due to the geometric configuration of the array antenna 35.

Corresponding radio chains 41, only one is shown in FIG. 3, are connected to the respective groups of antenna elements 36, each radio chain 41 comprising radio elements arranged for transmission, reception or both. The construction of radio chains is previously known, and will not be discussed further.

In the same way as for the first and second embodiment, when regarding one group of antenna elements 36, the corresponding radio chain 41 is connected to the antenna elements 37, 38, 39 in the group 36 one at a time by means of a switch 42. The switch 42 is arranged to switch the corresponding radio chain 41 between the three antenna elements 37, 38, 39 in the group of antenna elements 36 cyclically in essentially the same way as described for the first and second embodiments. Each group is connected to a corresponding radio chain via a corresponding cyclically switching switch.

The antenna elements 37, 38, 39 may each one be in the form of sub-antenna elements, for example patches. Then, each antenna element 37, 38, 39 constitutes a patch array antenna.

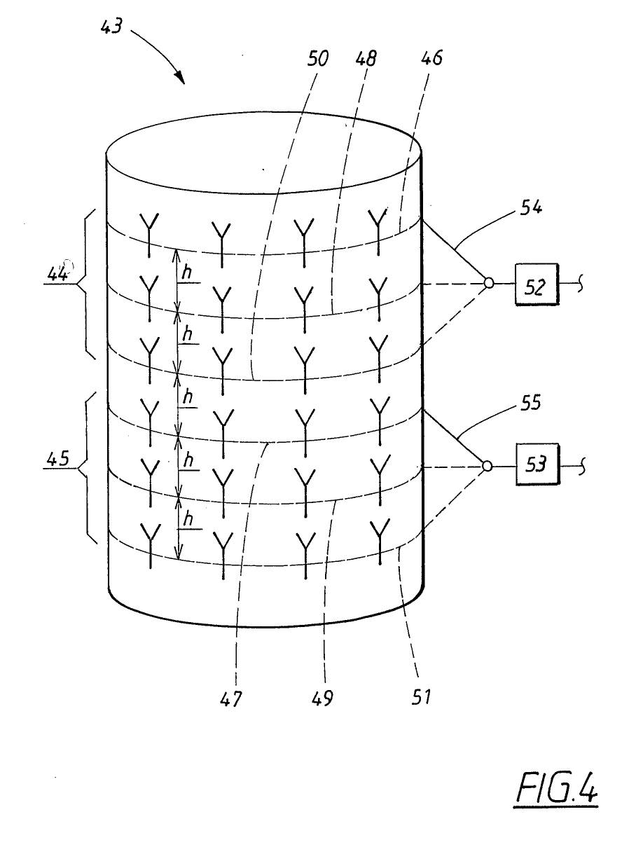

In FIG. 4, showing a fourth embodiment of the present invention, an array antenna 43 comprising a comprising a first group 44 of antenna elements and a second group of antenna elements 45 is shown. Each group 44, 45 comprises three antenna elements, each antenna element comprising connected antenna sub-elements placed along a respective first circumference 46, 47 of a circle, second circumference 48, 49 of a circle and third circumference 50, 51 of a circle. The circumferences 46, 47, 48, 49, 50, are essentially equidistant and a distance h between adjacent circumferences 46, 47, 48, 49, 50, 51 is λ/2, where λ is the wavelength that corresponds to the frequency used. Thus the distance between antenna sub-elements placed on adjacent circumferences 46, 47, 48, 49, 50, 51 is λ/2.

In the same way as for the previous embodiments, corresponding radio chains 52, 53 are cyclically connected to the antenna sub-elements on one circumference 46, 47, 48, 49, 50, 51 within each respective group 44, 45, one at a time, by means of corresponding switches 54, 55.

The antenna sub-elements may each one be in the form of for example patches, the antenna sub-elements on one circumference 46, 47, 48, 49, 50, 51 constituting a patch array antenna, each patch array antenna then constituting an antenna element.

The invention is not limited to the embodiments above, but may vary freely within the scope of the appended claims.

For example, the antenna elements 5, 6, 7, 8, 9, 10, 11, 12, 13; 23, 24, 25, 26, 27, 28, 29, 30 may be of many types. They may for example be wire antennas, patch antennas or slot antennas, having corresponding antenna element radiation lobes characteristics. As for the embodiment according to FIG. 4, each antenna element may comprise a number of sub-elements, each array antenna comprising a number of sub-array antennas.

The number of antenna elements 5, 6, 7, 8, 9, 10, 11, 12, 13; 23, 24, 25, 26, 27, 28, 29, 30 and number of groups 2, 3, 4; 21, 22 may vary, but there shall be at least two antenna elements and at least two groups. All groups comprise an equal amount of antenna elements.

The cycling may be irregular within the groups, such that the antenna elements in each group are connected to its corresponding radio chain during the same amount of time. In other words, the connection time for elements within the groups may vary. Such irregularities are the same between the groups.

The distance λ/2 between adjacent antenna elements is only approximate, an antenna design may use a distance between antenna elements that falls below λ/2, for example 0.4λ. It is of course of importance which frequency, in the frequency band used, that is used for calculating the distance between adjacent antenna elements. For example, the frequency corresponding to the wavelength λ, used for calculating the distance between adjacent antenna elements, may be chosen as the lowest frequency in the frequency band used in order to avoid grating lobes within the frequency band used.

The main idea is that the distance should be chosen in such a way that grating lobes do not appear for the frequency band used, but in practice grating lobes may start to appear when using the lower frequencies in the frequency band used.

The frequency band used normally corresponds to the modulation frequency.

What is claimed is:

1-14. (canceled)

15. A microwave array antenna arrangement, comprising:
at least two groups of antenna elements having at least two antenna elements in each group, all groups having an equal amount of antenna elements, each group of antenna elements being associated with one radio chain;
each group of antenna elements, further having one switch for each radio chain, the switches being arranged for cyclically connecting each radio chain to the antenna elements in each respective group of antenna elements.

16. A microwave array antenna arrangement according to claim 15, wherein the antenna elements in each group of antenna elements are arranged essentially equidistantly.

17. A microwave array antenna arrangement according to claim 15, wherein the distance between the antenna elements in each group of antenna elements is chosen in such a way that grating lobes do not appear for the frequency band used.

18. A microwave array antenna arrangement according to claim 16, wherein each antenna element comprises a number of antenna sub-elements, each antenna element constituting a sub-array antenna.

19. A microwave array antenna arrangement according to claim 18, wherein the antenna sub-elements are placed on circular circumferences.

20. A microwave array antenna arrangement according to claim 19, wherein the circular circumferences are of the same diameter.

21. A microwave array antenna arrangement according to claim 15, wherein the antenna elements are arranged essentially linearly.

22. A microwave array antenna arrangement according to claim 15, wherein the antenna elements are arranged along a circular circumference.

23. A microwave array antenna arrangement according to any claim 15, wherein only one antenna element per group of antenna elements is coupled to a respective radio chain at a time.

24. A microwave array antenna arrangement according to claim 23, wherein each antenna element in each group of antenna elements is coupled to its respective radio chain during essentially the same amount of time.

25. A microwave array antenna arrangement according to claim 23, wherein, during the cyclic switching, the distance between the antenna elements in each set of antenna elements being coupled to the radio chains at the same time is essentially the same for all such sets of antenna elements.

26. A microwave array antenna arrangement according to claim 25, wherein the distance between two adjacent groups of antenna elements is essentially the same as the distance between the antenna elements in each group.

27. A microwave array antenna arrangement according to claim 25, wherein the distance between two adjacent groups of antenna elements is greater than the distance between the antenna elements in each group.

28. A microwave array antenna arrangement according to claim 15, wherein each antenna element comprises at least one patch antenna.
